(19) United States
(12) Patent Application Publication
(10) Pub. No.: US 2023/0331985 A1
(43) Pub. Date: Oct. 19, 2023

(54) Polyamide Resin Composition and Molded Article Comprising the Same

(71) Applicant: LOTTE CHEMICAL CORPORATION, Seoul (KR)

(72) Inventors: Myeong Hwan KIM, Uiwang-si (KR); Sang Ki PARK, Uiwang-si (KR); Bong Jae LEE, Uiwang-si (KR); Jung Hun LEE, Uiwang-si (KR)

(21) Appl. No.: 18/135,277

(22) Filed: Apr. 17, 2023

(30) Foreign Application Priority Data
Apr. 18, 2022 (KR) 10-2022-0047574

(51) Int. Cl. B32B 27/34; B32B 27/18; B32B 7/12; C08L 77/06; C08K 3/34; C08K 7/14; B32B 17/10

(52) U.S. Cl. CPC C08L 77/06; B32B 7/12; B32B 17/10724; B32B 27/18; B32B 27/34; C08K 3/34; C08K 7/14; B32B 2255/26; B32B 2262/101; B32B 2270/00; B32B 2307/304; B32B 2307/546; B32B 2307/558; C08L 2205/03

(57) ABSTRACT

A polyamide resin composition includes: about 100 parts by weight of a polyamide resin including about 5% by weight (wt%) to about 55 wt% of an aromatic polyamide resin and about 45 wt% to about 95 wt% of an aliphatic polyamide resin; about 100 parts by weight to about 200 parts by weight of glass fiber; about 20 parts by weight to about 25 parts by weight of a poly(ether ester amide) block copolymer; and about 0.1 parts by weight to about 2 parts by weight of talc, wherein the poly(ether ester amide) block copolymer is a block copolymer of a reaction mixture including an amino carboxylic acid having 6 or more carbon atoms, a lactam or a salt of diamine-dicarboxylic acid, poly(tetramethylene glycol), and a dicarboxylic acid having 4 to 20 carbon atoms. The polyamide resin composition can have good properties in terms of bonding strength and detachability with respect to a polyurethane bonding agent, impact resistance, heat resistance, rigidity, and the like.

### CROSS-REFERENCE TO RELATED APPLICATION

This application claims priority under 35 USC Section 119 to and the benefit of Korean Patent Application No. 10-2022-0047574, filed in the Korean Intellectual Property Office on Apr. 18, 2022, the entire disclosure of which is incorporated herein by reference.

### FIELD OF THE INVENTION

The present invention relates to a polyamide resin composition and a molded article comprising the same.

### BACKGROUND

A polyamide resin can have good processability and impact resistance and is advantageously used in housings of various products, interior/exterior materials of automobiles, and the like. The polyamide resin may be mixed with inorganic fillers, such as glass fibers and the like, to improve heat resistance, mechanical properties including rigidity, and the like. Polyamide resins have also been proposed for use in housings of electronic products in view of trends toward compactness and weight reduction.

Components of electric/electronic products, automobiles, and the like can be assembled in a bonding process using a bonding tape or a bonding agent. A bonding process using a PUR (polyurethane reactive) type polyurethane bonding agent can be simpler than a bonding process using a bonding tape. The PUR type polyurethane bonding agent can advantageously improve productivity and ensure good adhesion. In particular, the PUR type polyurethane bonding agent can have good efficiency when a bonding area is narrow.

However, application of the polyurethane bonding agent is limited due to very poor adhesion with respect to a polyamide resin.

Therefore, there is a need for a polyamide resin composition that ensures improvement in adhesion and detachability with respect to a polyurethane bonding agent to provide a polyamide resin with applicability to various industrial fields.

### SUMMARY OF THE INVENTION

The present disclosure is directed to a polyamide resin composition, which can have good properties in terms of bonding strength and detachability with respect to a polyurethane bonding agent, impact resistance, heat resistance, rigidity, and the like, and a molded article comprising the same.

The polyamide resin composition may include: about 100 parts by weight of a polyamide resin including about 5% by weight (wt%) to about 55 wt% of an aromatic polyamide resin and about 45 wt% to about 95 wt% of an aliphatic polyamide resin; about 100 parts by weight to about 200 parts by weight of glass fiber; about 20 parts by weight to about 25 parts by weight of a poly(ether ester amide) block copolymer; and about 0.1 parts by weight to about 2 parts by weight of talc, wherein the poly(ether ester amide) block copolymer is a block copolymer of a reaction mixture including an amino carboxylic acid having 6 or more carbon atoms, a lactam or a salt of diamine-dicarboxylic acid, polytetramethylene glycol, and a dicarboxylic acid having 4 to 20 carbon atoms.

The aromatic polyamide resin may be a polymer of an aliphatic dicarboxylic acid and an aromatic diamine.

Examples of the aliphatic polyamide resin may include polyamide 11, polyamide 12, polyamide 4.6, polyamide 6.6, polyamide 6.10, polyamide 6.12, polyamide 10.10, polyamide 10.12, and the like, and combinations and/or mixtures thereof.

The glass fiber may have a rectangular or elliptical cross-section, a cross-section aspect ratio (a ratio of a long-side length/short-side length in cross-section) of about 1.5 to about 10, and a short-side length of about 2 µm to about 10 µm in cross-section.

The glass fiber and the poly(ether ester amide) block copolymer may be present in a weight ratio of about 1:0.1 to about 1:0.2.

The poly(ether ester amide) block copolymer and the talc may be present in a weight ratio of about 1:0.005 to about 1:0.08.

The polyamide resin composition may have a bonding strength (potential energy) of about 700 mJ to about 950 mJ, as measured upon detachment of a specimen having a size of 50 mm × 50 mm × 4 mm from a glass plate having a size of 25 mm × 25 mm × 0.7 mm by dropping a dart having a mass of 10 g to 500 g from a height of 50 cm onto the specimen using a dropping tester, with the dart secured to an upper end of the dropping tester and the specimen secured to a lower end thereof, in accordance with a DuPont drop test, in which 0.018 g of a polyurethane-based bonding agent (e.g., EH9777BS, H.B. Fuller Co., Ltd.) is coated to a thickness of 1 mm on the specimen at 110° C. and the glass plate is attached to the specimen via the bonding agent, followed by curing the bonding agent at 25° C. and 50% relative humidity (RH) for 72 hours.

The polyamide resin composition may prevent a bonding agent from remaining on a specimen having a size of 50 mm × 50 mm × 4 mm upon detachment of the specimen from a glass plate having a size of 25 mm × 25 mm × 0.7 mm by dropping a dart having a diameter of 5 mm onto the specimen at a dropping rate of 20 mm/min using a universal testing machine (UTM), with the dart secured to an upper jig of the UTM and the glass plate secured to a lower end thereof, in which 0.018 g of a polyurethane-based bonding agent (e.g., EH9777BS, H.B. Fuller Co., Ltd.) is coated to a thickness of 1 mm on the specimen at 110° C. and the glass plate is attached to the specimen via the bonding agent, followed by curing the bonding agent at 25° C. and 50% RH for 72 hours and heating the bonding agent at 75° C. for 15 min.

The polyamide resin composition may have a notched Izod impact strength of about 14 kgf·cm/cm to about 30 kgf·cm/cm, as measured on a ⅛″ thick specimen in accordance with ASTM D256.

The polyamide resin composition may have a heat deflection temperature (HDT) of about 175° C. to about 190° C., as measured under a load of 1.82 MPa at a heating rate of 120° C./hr in accordance with ASTM D648.

The polyamide resin composition may have a flexural modulus of about 90,000 kgf/cm² to about 180,000 kgf/cm², as measured on a 6.4 mm thick specimen at a rate of 2.8 mm/min in accordance with ASTM D790.

The present disclosure also relates to a molded article formed of the polyamide resin composition according to any embodiments of the present disclosure.

The present disclosure also relates to an electronic device housing including a glass frame and a plastic member formed of the polyamide resin composition according to any embodiments of the present disclosure adjoining at least one surface of the glass frame.

### BRIEF DESCRIPTION OF THE DRAWINGS

FIG. 1 is a schematic sectional view of an electronic device housing according to one embodiment of the present invention.

### DETAILED DESCRIPTION

The above and other aspects, features, and advantages of the present invention will become apparent from the detailed description of the following embodiments. It should be understood that the present invention is not limited to the following embodiments and may be embodied in different ways by those skilled in the art without departing from the scope of the present invention. Rather, the embodiments are provided for complete disclosure and to provide thorough understanding of the present invention by those skilled in the art. The scope of the present invention should be defined only by the appended claims.

Hereinafter, exemplary embodiments of the present invention will be described in detail.

A polyamide resin composition according to the present invention includes: (A) an aromatic polyamide resin; (B) an aliphatic polyamide resin; (C) glass fiber; (D) a poly(ether ester amide) block copolymer; and (E) talc.

As used herein to represent a specific numerical range, “a to b” is defined as “≥a and <b”.

### (A) Aromatic Polyamide Resin

The aromatic polyamide resin according to the present disclosure can serve to improve the properties of the polyamide resin composition in terms of bonding strength and detachability with respect to a polyurethane bonding agent, impact resistance, heat resistance, rigidity, and the like together with the aliphatic polyamide resin, the glass fiber, the poly(ether ester amide) block copolymer and talc, and may be an aromatic polyamide resin used in typical polyamide resin compositions.

In some embodiments, the aromatic polyamide resin may be a polymer of an aliphatic dicarboxylic acid and an aromatic diamine, which is prepared by a polymerization method known to those skilled in the art.

Herein, the term “dicarboxylic acid” and the like includes dicarboxylic acid, alkyl esters thereof (e.g., C₁ to C₄ lower alkyl esters, such as monomethyl, monoethyl, dimethyl, diethyl or dibutyl ester, and the like), and acid anhydrides thereof. The dicarboxylic acid forms a repeat unit (dicarboxylic acid moiety) derived from dicarboxylic acid through reaction with diamine and the like. In addition, as used herein, the terms “a repeat unit derived from dicarboxylic acid” and “a repeat unit (diamine moiety) derived from diamine” refers to residues remaining after removal of a hydroxyl group or an alkoxy group (removed from a carboxylic acid group) and removal of a hydrogen atom (removed from an amine group) upon polymerization of the dicarboxylic acid and the diamine, respectively.

In some embodiments, the aliphatic dicarboxylic acid may be a C₆ to C₂₀ linear, branched, or cyclic aliphatic dicarboxylic acid, for example, adipic acid, sebacic acid, 1,4-cyclohexanedicarboxylic acid, 1,3-cyclohexanedicarboxylic acid, and the like, and combinations and/or mixtures thereof. For example, the aliphatic dicarboxylic acid may be adipic acid or sebacic acid.

In some embodiments, the aromatic diamine may include at least one type of C₆ to C₃₀ aromatic diamine. For example, the aromatic diamine may be selected from among phenylene diamine compounds, such as m-phenylene diamine and p-phenylene diamine, xylylene diamine compounds, such as m-xylylene diamine and p-xylylene diamine, naphthalene diamine compounds, and the like, and combinations and/or mixtures thereof.

In some embodiments, in the aromatic polyamide resin, a mole ratio of the repeat unit derived from the dicarboxylic acid to the repeat unit derived from the diamine (dicarboxylic acid/diamine) may range from about 0.95 to about 1.15, for example, from about 1.00 to about 1.10. Within this range, the polyamide resin composition can form a polyamide resin having a suitable degree of polymerization for molding and can prevent deterioration in properties due to unreacted monomers.

In some embodiments, the aromatic polyamide resin may have a glass transition temperature of about 30° C. to about 100° C., for example, about 40° C. to about 80° C., as measured by differential scanning calorimetry (DSC). Within this range, the polyamide resin composition can exhibit good properties in terms of heat resistance, rigidity, impact resistance, and the like.

In addition, the aromatic polyamide resin may have an inherent viscosity [η] of about 0.7 dL/g to about 1.2 dL/g, for example, about 0.8 dL/g to about 1.0 dL/g, as measured on a sample using an Ubbelohde viscometer at 25° C., in which the sample is prepared by dissolving the aromatic polyamide resin to a concentration of 0.5 g/dL in a concentrated sulfuric acid solution (98%). Within this range, the polyamide resin composition can have good properties in terms of heat resistance, rigidity, impact resistance, and the like.

The aromatic polyamide resin may be present in an amount of about 5 wt% to about 55 wt%, for example, about 14 wt% to about 45 wt%, based on 100 wt% of all of the polyamide resins (including the aromatic polyamide resin and the aliphatic polyamide resin). In some embodiments, the aromatic polyamide resin may be present in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt%, based on 100 wt% of all of the polyamide resins (including the aromatic polyamide resin and the aliphatic polyamide resin). Further, according to some embodiments, the aromatic polyamide resin can be present in an amount of from about any of the foregoing amounts to about any other of the foregoing amounts.

If the content of the aromatic polyamide resin is less than about 5 wt%, the polyamide resin composition can suffer from detachability and the like, and if the content of the aromatic polyamide resin exceeds about 55 wt%, the polyamide resin composition can suffer from deterioration in impact resistance, heat resistance, and the like.

### (B) Aliphatic Polyamide Resin

The aliphatic polyamide resin according to the present disclosure can serve to improve the properties of the polyamide resin composition in terms of bonding strength and detachability with respect to a polyurethane bonding agent, impact resistance, heat resistance, rigidity, and the like together with the aromatic polyamide resin, the glass fiber, the poly(ether ester amide) block copolymer and talc, and may be an aliphatic polyamide resin used in typical polyamide resin compositions.

In some embodiments, examples of the aliphatic polyamide resin may include without limitation polyamide 11, polyamide 12, polyamide 4.6, polyamide 6.6, polyamide 6.10, polyamide 6.12, polyamide 10.10, polyamide 10.12, and the like, and combinations and/or mixtures thereof.

In some embodiments, the aliphatic polyamide resin may have a relative viscosity [ηᵣₑₗ] of about 2 to about 3, for example, about 2.3 to about 2.8, as measured on a sample using an Ubbelohde viscometer at 25° C., in which the sample is prepared by dissolving the aliphatic polyamide resin to a concentration of 0.5 g/dL in a concentrated sulfuric acid solution (96%). Within this range, the polyamide resin composition can have good processability and impact resistance.

The aliphatic polyamide resin may be present in an amount of about 45 wt% to about 95 wt%, for example, about 55 wt% to about 86 wt%, based on 100 wt% of all of the polyamide resins (including the aromatic polyamide resin and the aliphatic polyamide resin). In some embodiments, the aliphatic polyamide resin may be present in an amount of about 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt%, based on 100 wt% of all of the polyamide resins (including the aromatic polyamide resin and the aliphatic polyamide resin). Further, according to some embodiments, the aliphatic polyamide resin can be present in an amount of from about any of the foregoing amounts to about any other of the foregoing amounts.

If the content of the aliphatic polyamide resin is less than about 45 wt%, the polyamide resin composition can suffer from deterioration in impact resistance, heat resistance, and the like, and if the content of the aliphatic polyamide resin exceeds about 95 wt%, the polyamide resin composition can suffer from deterioration in detachability and the like.

### (C) Glass Fiber

The glass fiber according to the present disclosure can serve to improve the properties of the polyamide resin composition in terms of bonding strength and detachability with respect to a polyurethane bonding agent, impact resistance, heat resistance, rigidity, and the like together with the aromatic polyamide resin, the aliphatic polyamide resin, the poly(ether ester amide) block copolymer and talc, and may be glass fiber used in typical polyamide resin compositions.

In some embodiments, the glass fiber may have a cross-section of various shapes, such as a circular shape, an elliptical shape, a rectangular shape, and the like.

In some embodiments, the glass fiber may be a flat type glass fiber having a rectangular or elliptical cross-section. The flat type glass fiber may have a cross-section aspect ratio (ratio of long-side length/short-side length in cross-section) of about 1.5 to about 10, for example, about 2 to about 8, a short-side length of about 2 µm to about 10 µm, for example, about 4 µm to about 8 µm, in cross-section, and a pre-processing length of about 1 mm to about 15 mm, for example, about 2 to about 8 mm, as measured using a scanning electron microscope (SEM). Within this range, the polyamide resin composition can achieve improvement in rigidity, processability, and the like.

In some embodiments, the glass fiber may be subjected to surface treatment using a typical surfactant.

The polyamide resin composition may include the glass fiber in an amount of about 100 to about 200 parts by weight, for example, about 120 to about 180 parts by weight, relative to about 100 parts by weight of the polyamide resin (including the aromatic polyamide resin and the aliphatic polyamide resin). In some embodiments, the polyamide resin composition may include the glass fiber in an amount of about 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, or 200 parts by weight, relative to about 100 parts by weight of the polyamide resin (including the aromatic polyamide resin and the aliphatic polyamide resin). Further, according to some embodiments, the glass fiber can be present in an amount of from about any of the foregoing amounts to about any other of the foregoing amounts.

If the content of the glass fiber is less than about 100 parts by weight relative to about 100 parts by weight of the polyamide resin, the polyamide resin composition can suffer from deterioration in impact resistance, heat resistance, rigidity, and the like, and if the content of the glass fiber exceeds about 200 parts by weight relative to about 100 parts by weight of the polyamide resin, the polyamide resin composition can suffer from deterioration in adhesion and detachability.

### (D) Poly(Ether Ester Amide) Block Copolymer

The poly(ether ester amide) block copolymer according to the present disclosure can serve to improve the properties of the polyamide resin composition in terms of bonding strength and detachability with respect to a polyurethane bonding agent, impact resistance, heat resistance, rigidity, and the like together with the aromatic polyamide resin, the aliphatic polyamide resin, the glass fiber and talc. The poly(ether ester amide) block copolymer may be a block copolymer of a reaction mixture including an amino carboxylic acid having 6 or more carbon atoms, a lactam or a salt of diamine-dicarboxylic acid, polytetramethylene glycol, and a dicarboxylic acid having 4 to 20 carbon atoms.

In some embodiments, examples of the amino carboxylic acid having 6 or more carbon atoms may include without limitation ω-aminocaproic acid, ω-amino oenanthic acid, ω-aminocaprylic acid, ω-aminononanoic acid, ω-aminocapric acid, 11-aminoundecanoic acid, 12-aminododecanoic acid, and the like, and combinations and/or mixtures thereof. In some embodiments, examples of the lactam may include without limitation caprolactam, oenantholactam, caprylic lactam, laurolactam, and the like, and combinations and/or mixtures thereof. In some embodiments, examples of the salt of diamine-dicarboxylic acid may include without limitation a salt of hexamethylene diamine-adipic acid, a salt of hexamethylene diamine-isophthalic acid, and the like, and combinations and/or mixtures thereof. For example, 12-aminododecanoic acid, caprolactam, or a salt of hexamethylene diamine-adipic acid may be used.

In some embodiments, examples of the dicarboxylic acid having 4 to 20 carbon atoms may include without limitation terephthalic acid, 1,4-cyclohexanedicarboxylic acid, sebacic acid, adipic acid, dodecanedioic acid, and the like, and combinations and/or mixtures thereof.

Specifically, a bond between the amino carboxylic acid having 6 or more carbon atoms, the lactam or the salt of diamine-dicarboxylic acid and the polytetramethylene glycol may be an ester bond; a bond between the amino carboxylic acid having 6 or more carbon atoms, the lactam or the salt of diamine-dicarboxylic acid and the dicarboxylic acid having 4 to 20 carbon atoms may be an amide bond; and a bond between the polytetramethylene glycol and the dicarboxylic acid having 4 to 20 carbon atoms may be an ester bond.

In some embodiments, the poly(ether ester amide) block copolymer may be prepared by a preparation method known to those skilled in the art. For example, the poly(ether ester amide) block copolymer may be prepared by a method disclosed in JP Patent Publication No. S56-045419 and JP Unexamined Patent Publication No. S55-133424.

In some embodiments, the poly(ether ester amide) block copolymer may include about 10 wt% to about 95 wt% of a polyether-ester block. Within this range, the polyamide resin composition can exhibit good impact resistance.

The polyamide resin composition may include the poly(ether ester amide) block copolymer in an amount of about 20 to about 25 parts by weight, for example, about 21 to about 24 parts by weight, relative to about 100 parts by weight of the polyamide resin (including the aromatic polyamide resin and the aliphatic polyamide resin). In some embodiments, the polyamide resin composition may include the poly(ether ester amide) block copolymer in an amount of about 20, 21, 22, 23, 24, or 25 parts by weight, relative to about 100 parts by weight of the polyamide resin (including the aromatic polyamide resin and the aliphatic polyamide resin). Further, according to some embodiments, the poly(ether ester amide) block copolymer can be present in an amount of from about any of the foregoing amounts to about any other of the foregoing amounts.

If the content of the poly(ether ester amide) block copolymer is less than about 20 parts by weight relative to about 100 parts by weight of the polyamide resin, the polyamide resin composition can suffer from deterioration in adhesion and the like, and if the content of the poly(ether ester amide) block copolymer exceeds about 25 parts by weight relative to about 100 parts by weight of the polyamide resin, the polyamide resin composition can suffer from deterioration in detachability and the like.

In some embodiments, the glass fiber (C) and the poly(ether ester amide) block copolymer (D) may be present in a weight ratio (C:D) of about 1:0.1 to about 1:0.2, for example, about 1:0.11 to about 1:0.19. In some embodiments, the glass fiber (C) and the poly(ether ester amide) block copolymer (D) may be present in a weight ratio (C:D) of about 1:0.1, 1:0.11, 1:0.12, 1:0.13, 1:0.14, 1:0.15, 1:0.16, 1:0.17, 1:0.18, 1:0.19, or 1:0.2. Further, according to some embodiments, the glass fiber (C) and the poly(ether ester amide) block copolymer (D) may be present in a weight ratio (C:D) of from about any of the foregoing weight ratios to about any other of the foregoing weight ratios.

Within this range, the polyamide resin composition can exhibit better adhesion, detachment, and the like.

### (E) Talc

Talc according to the present disclosure can serve to improve the properties of the polyamide resin composition in terms of bonding strength and detachability with respect to a polyurethane bonding agent, impact resistance, heat resistance, rigidity, and the like together with the aromatic polyamide resin, the aliphatic polyamide resin, the glass fiber, and the poly(ether ester amide) block copolymer, and may be talc used in typical polyamide resin compositions.

In some embodiments, the talc may be flake type inorganic fillers and may have an average particle diameter (median volume-weighted diameter D50) of about 0.5 µm to about 10 µm, for example, about 1 µm to about 7 µm, as measured by a particle analyzer using techniques and equipment known in the art (e.g., using laser diffraction techniques to measure volume-weighted diameter, such as median volume-weighted diameter D50, using a particle size analyzer such as the Malvern Mastersizer 3000). In some embodiments, the talc may have an average particle diameter (median volume-weighted diameter D50) of about 0.5, 1, 1.5, 2, 2.5, 3, 3.5, 4, 4.5, 5, 5.5, 6, 6.5, 7, 7.5, 8, 8.5, 9, 9.5, or 10 µm. Further, according to some embodiments, the talc can have an average particle diameter of from about any of the foregoing average particle diameters to about any other of the foregoing average particle diameters.

Within this range, the polyamide resin composition can exhibit good adhesion, detachment, heat resistance, and the like.

The polyamide resin composition may include the talc in an amount of about 0.1 to about 2 parts by weight, for example, about 0.2 to about 1 part by weight, relative to about 100 parts by weight of the polyamide resin (including the aromatic polyamide resin and the aliphatic polyamide resin). In some embodiments, the polyamide resin composition may include the talc in an amount of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2 parts by weight, relative to about 100 parts by weight of the polyamide resin (including the aromatic polyamide resin and the aliphatic polyamide resin). Further, according to some embodiments, the talc can be present in an amount of from about any of the foregoing amounts to about any other of the foregoing amounts.

If the content of the talc is less than about 0.1 parts by weight relative to about 100 parts by weight of the polyamide resin, the polyamide resin composition can suffer from deterioration in heat resistance and the like, and if the content of the talc exceeds about 2 parts by weight relative to about 100 parts by weight of the polyamide resin, the polyamide resin composition can suffer from deterioration in impact resistance and the like.

In some embodiments, the poly(ether ester amide) block copolymer (D) and the talc (E) may be present in a weight ratio (D:E) of about 1:0.005 to about 1:0.08, for example, about 1:0.008 to about 1:0.06. In some embodiments, the poly(ether ester amide) block copolymer (D) and the talc (E) may be present in a weight ratio (D:E) of about 1:0.005, 1:0.006, 1:0.007, 1:0.008, 1:0.009, 1:0.01, 1:0.02, 1:0.03, 1:0.04, 1:0.05, 1:0.06, 1:0.07, or 1:0.08. Further, according to some embodiments, the poly(ether ester amide) block copolymer (D) and the talc (E) may be present in a weight ratio of from about any of the foregoing weight ratios to about any other of the foregoing weight ratios.

Within this range, the polyamide resin composition can exhibit good properties in terms of adhesion, detachment, heat resistance, rigidity, and the like.

The polyamide resin composition according to the present disclosure may further include typical additive(s), as needed, so long as the additives do not inhibit the effects of the present invention. Examples of the additives may include heat stabilizers, flame retardants, antioxidants, lubricants, release agents, nucleating agents, colorants, and the like, and combinations and/or mixtures thereof, without being limited thereto. The polyamide resin composition may include additive(s) in an amount of about 0.001 to about 40 parts by weight, for example, about 0.1 to about 20 parts by weight, relative to about 100 parts by weight of the polyamide resin (including the aromatic polyamide resin and the aliphatic polyamide resin). In some embodiments, the polyamide resin composition may include the additive(s) in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 parts by weight, relative to about 100 parts by weight of the polyamide resin (including the aromatic polyamide resin and the aliphatic polyamide resin). Further, according to some embodiments, the additive(s) can be present in an amount of from about any of the foregoing amounts to about any other of the foregoing amounts.

The polyamide resin composition according to one embodiment may be prepared in pellet form by mixing the aforementioned components, followed by melt extrusion in a typical twin screw extruder at 240° C. to 320° C., for example, at 250° C. to 310° C.

In some embodiments, the polyamide resin composition may have a bonding strength (potential energy of) of about 700 mJ to about 950 mJ, for example, about 750 mJ to about 900 mJ, as measured upon detachment of a specimen having a size of 50 mm × 50 mm × 4 mm from a glass plate having a size of 25 mm × 25 mm × 0.7 mm by dropping a dart having a mass of 10 g to 500 g from a height of 50 cm onto the specimen using a dropping tester, with the dart secured to an upper end of the dropping tester and the specimen secured to a lower end thereof, in accordance with a DuPont drop test, in which 0.018 g of a polyurethane-based bonding agent (e.g., EH9777BS, H.B. Fuller Co., Ltd.) is coated to a thickness of 1 mm on the specimen at 110° C. and the glass plate is attached to the specimen via the bonding agent, followed by curing the bonding agent at 25° C. and 50% RH for 72 hours.

In some embodiments, the polyamide resin composition may prevent a bonding agent from remaining on a specimen having a size of 50 mm × 50 mm × 4 mm upon detachment of the specimen from a glass plate having a size of 25 mm × 25 mm × 0.7 mm by dropping a dart having a diameter of 5 mm onto the specimen at a dropping rate of 20 mm/min using a universal testing machine (UTM), with the dart secured to an upper jig of the UTM and the glass plate secured to a lower end thereof, in which 0.018 g of a polyurethane-based bonding agent (e.g., EH9777BS, H.B. Fuller Co., Ltd.) is coated to a thickness of 1 mm on the specimen at 110° C. and the glass plate is attached to the specimen via the bonding agent, followed by curing the bonding agent at 25° C. and 50% RH for 72 hours and heating the bonding agent at 75° C. for 15 min.

In some embodiments, the polyamide resin composition may have a notched Izod impact strength of about 14 kgf·cm/cm to about 30 kgf·cm/cm, for example, about 15 kgf·cm/cm to about 25 kgf·cm/cm, as measured on a ⅛″ thick specimen in accordance with ASTM D256.

In some embodiments, the polyamide resin composition may have a heat deflection temperature (HDT) of about 175° C. to about 190° C., for example, about 177° C. to about 187° C., as measured under a load of 1.82 MPa at a heating rate of 120° C./hr in accordance with ASTM D648.

In some embodiments, the polyamide resin composition may have a flexural modulus of about 90,000 kgf/cm² to about 180,000 kgf/cm², for example, about 100,000 kgf/cm² to about 150,000 kgf/cm², as measured on a 6.4 mm thick specimen at a rate of 2.8 mm/min in accordance with ASTM D790.

The present disclosure also relates to a molded article produced from the polyamide resin composition according to any embodiments of the present disclosure. The molded article may be formed of the polyamide resin composition through various molding methods, such as but not limited to injection molding, extrusion molding, vacuum molding, casting, and the like.

The present disclosure also relates to an electronic device housing including a glass frame and a plastic member produced from the polyamide resin composition according to any embodiments of the present disclosure adjoining at least one surface of the glass frame.

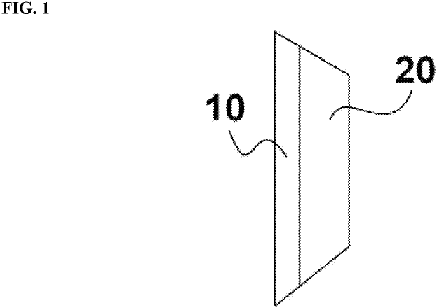

FIG. 1 is a schematic sectional view of an electronic device housing according to one embodiment. Although lengths, thicknesses or widths of components constituting the present invention may be exaggerated in the drawings for clarity, it should be understood that the present invention is not limited thereto. Referring to FIG. 1, the electronic device housing according to the embodiment includes a glass frame 10 and a plastic member 20 adjoining at least one surface of the glass frame 10, in which the plastic member is formed of the polyamide resin composition according to any embodiments of the present disclosure.

In some embodiments, the glass frame 10 and the plastic member 20 may have various shapes without being limited to the shapes shown in the drawings. Here, the glass frame 10 may adjoin at least one surface of the plastic member 20. In some embodiments, the plastic member 20 and the glass frame 10 may be adjoined (e.g., bonded) to each other using a polyurethane bonding agent.

In some embodiments, the glass frame 10 may be selected from any products applicable to typical electronic device housings or may be commercially available.

In some embodiments, the plastic member 20 may be formed of the polyamide resin composition according to any embodiments of the present disclosure through various molding methods, such as but not limited to injection molding, extrusion molding, vacuum molding, casting, and the like. Specifically, the plastic member 20 may be an interior material of electric and/or electronic devices and the like.

Next, the present invention will be described in more detail with reference to the following examples. It should be understood that these examples are provided for illustration only and are not to be construed in any way as limiting the present invention.

### EXAMPLE

Details of components used in the following examples and comparative examples are as follows.

### (A) Aromatic Polyamide Resin

Polyamide MXD10 (Manufacturer: Mitsubishi Gas Chemical Co., Ltd., Product Name: LEXTER8000) is used.

### (B) Aliphatic Polyamide Resin

Polyamide 10.12 (Manufacturer: Shandong Guangyin New Materials Co., Ltd., Product Name: B150) is used.

### (C) Glass Fiber

Flat glass fibers (Manufacturer: Nittobo Co., Ltd., Product Name: CSG 3PA-820) are used.

### (D) Poly(Ether Ester Amide) Block Copolymer

(D1) A polyamide 12-polytetramethylene oxide block copolymer (Manufacturer: Evonik, Product Name: Vestamid E62-S3) is used.

(D2) A polyamide 6-polyethylene oxide block copolymer (PA6-b-PEO, Manufacturer: Sanyo Chemical Co., Ltd., Product Name: Pelestat 1251) is used.

### (E) Talc

Talc (Manufacturer: KOCH, Product Name: KCM-6300C) is used.

### Examples 1 to 9 and Comparative Examples 1 to 9

The aforementioned components are mixed in amounts as listed in Tables 1 to 4, followed by extrusion at 260° C., thereby preparing a thermoplastic resin composition in pellet form. Here, extrusion is performed using a twin-screw extruder (L/D: 44, Φ: 45 mm). The prepared pellets are dried at 80° C. for 4 hours or more and then subjected to injection molding using a 6 oz. injection machine (molding temperature: 280° C., mold temperature: 80° C.), thereby preparing specimens. The prepared specimens are evaluated as to the following properties. Results are shown in Tables 1, 2, 3 and 4.

### Property Evaluation

Bonding strength (potential energy, unit: mJ): Bonding strength (potential energy) is measured upon detachment of a specimen having a size of 50 mm × 50 mm × 4 mm from a glass plate having a size of 25 mm × 25 mm × 0.7 mm by dropping a dart having a mass of 10 g to 500 g from a height of 50 cm onto the specimen using a dropping tester, with the dart secured to an upper end of the dropping tester and the specimen secured to a lower end thereof, in accordance with a DuPont drop test, in which 0.018 g of a polyurethane-based bonding agent (e.g., EH9777BS, H.B. Fuller Co., Ltd.) is coated to a thickness of 1 mm on the specimen at 110° C. and the glass plate is attached to the bonding agent on the specimen, followed by curing the bonding agent at 25° C. and 50% RH for 72 hours.

Potential energy (Ep) = mass (mass of dart upon detachment) × 9.8 (acceleration of gravity) × 50 (height of weight upon detachment)

Evaluation of detachability: The presence of a bonding agent remaining on a specimen (50 mm × 50 mm × 4 mm) is checked upon detachment of the specimen from a glass plate (25 mm × 25 mm × 0.7 mm) by dropping a dart having a diameter of 5 mm onto the specimen at a dropping rate of 20 mm/min using a universal testing machine (UTM), with the dart secured to an upper jig of the UTM and the glass plate secured to a lower end thereof, in which 0.018 g of a polyurethane-based bonding agent (e.g., EH9777BS, H.B. Fuller Co., Ltd.) is coated to a thickness of 1 mm on the specimen at 110° C. and the glass plate is attached to the bonding agent on the specimen, followed by curing the bonding agent at 25° C. and 50% RH for 72 hours and heating the bonding agent at 75° C. for 15 min. (OK: no residual bonding agent, NG: residual bonding agent)

Notched Izod impact resistance (unit: kgf·cm/cm): Notched Izod impact strength is measured on a ⅛″ thick specimen in accordance with ASTM D256.

Heat deflection temperature (HDT) (unit: °C): HDT is measured under a load of 1.82 MPa at a heating rate of 120° C./hr in accordance with ASTM D648.

Flexural modulus (unit: kgf/cm²): Flexural modulus is measured on a 6.4 mm thick specimen at a rate of 2.8 mm/min in accordance with ASTM D790.

TABLE 1

Example

| | | | | | |
|---|---|---|---|---|---|
| | 1 | 2 | 3 | 4 | 5 |
| (A) (wt%) | 14.6 | 29.3 | 45 | 29.3 | 29.3 |
| (B) (wt%) | 85.4 | 70.7 | 55 | 70.7 | 70.7 |
| (C) (parts by weight) | 144 | 144 | 144 | 120 | 180 |
| (D1) (parts by weight) | 22 | 22 | 22 | 22 | 22 |
| (D2) (parts by weight) | - | - | - | - | - |
| (E) (parts by weight) | 0.49 | 0.49 | 0.49 | 0.49 | 0.49 |
| Bonding strength | 850 | 850 | 860 | 880 | 750 |
| Detachability | OK | OK | OK | OK | OK |
| Notched Izod impact strength | 18.2 | 18.5 | 16.5 | 15.7 | 18.3 |
| HDT | 182 | 182 | 180 | 178 | 185 |
| Flexural modulus | 120,000 | 120,000 | 120,000 | 100,000 | 140,000 |

^{∗} parts by weight: parts by weight relative to 100 parts by weight of polyamide resin (A+B)

TABLE 2

Example

| | | | | |
|---|---|---|---|---|
| | 6 | 7 | 8 | 9 |
| (A) (wt%) | 29.3 | 29.3 | 29.3 | 29.3 |
| (B) (wt%) | 70.7 | 70.7 | 70.7 | 70.7 |
| (C) (parts by weight) | 144 | 144 | 144 | 144 |
| (D1) (parts by weight) | 21 | 24 | 22 | 22 |
| (D2) (parts by weight) | - | - | - | - |
| (E) (parts by weight) | 0.49 | 0.49 | 0.2 | 1 |
| Bonding strength | 820 | 880 | 850 | 850 |
| Detachability | OK | OK | OK | OK |
| Notched Izod impact strength | 17.8 | 18.8 | 19.5 | 17.5 |
| HDT | 181 | 183 | 181 | 184 |
| Flexural modulus | 128,000 | 110,000 | 120,000 | 120,000 |

^{∗} parts by weight: parts by weight relative to 100 parts by weight of polyamide resin (A+B)

TABLE 3

Comparative Example

| | | | | |
|---|---|---|---|---|
| | 1 | 2 | 3 | 4 |
| (A) (wt%) | 1 | 60 | 29.3 | 29.3 |
| (B) (wt%) | 99 | 40 | 70.7 | 70.7 |
| (C) (parts by weight) | 144 | 144 | 90 | 210 |
| (D1) (parts by weight) | 22 | 22 | 22 | 22 |
| (D2) (parts by weight) | - | - | - | - |
| (E) (parts by weight) | 0.49 | 0.49 | 0.49 | 0.49 |
| Bonding strength | 1,050 | 800 | 850 | 600 |
| Detachability | NG | OK | OK | NG |
| Notched Izod impact strength | 19.0 | 13.7 | 13.6 | 19.8 |
| HDT | 183 | 174 | 172 | 195 |
| Flexural modulus | 120.000 | 100,000 | 85,000 | 160,000 |

^{∗} parts by weight: parts by weight relative to 100 parts by weight of polyamide resin (A+B)

TABLE 4

Comparative Example

| | | | | | |
|---|---|---|---|---|---|
| | 5 | 6 | 7 | 8 | 9 |
| (A) (wt%) | 29.3 | 29.3 | 29.3 | 29.3 | 29.3 |
| (B) (wt%) | 70.7 | 70.7 | 70.7 | 70.7 | 70.7 |
| (C) (parts by weight) | 144 | 144 | 144 | 144 | 144 |
| (D1) (parts by weight) | 15 | 30 | - | 22 | 22 |
| (D2) (parts by weight) | - | - | 22 | - | - |
| (E) (parts by weight) | 0.49 | 0.49 | 0.49 | 0.05 | 3 |
| Bonding strength | 550 | 1,050 | 900 | 860 | 800 |
| Detachability | OK | NG | NG | OK | OK |
| Notched Izod impact strength | 16.5 | 19.7 | 17.8 | 18.5 | 13.8 |
| HDT | 182 | 181 | 182 | 174 | 182 |
| Flexural modulus | 125,000 | 95,000 | 120,000 | 120,000 | 110,000 |

^{∗} parts by weight: parts by weight relative to 100 parts by weight of polyamide resin (A+B)

From the above result, it can be seen that the polyamide resin compositions according to the present disclosure exhibit good properties in terms of adhesion (bonding strength) and detachability with respect to a polyurethane bonding agent, impact resistance (notched Izod impact strength), heat resistance (HDT), rigidity (flexural modulus), and the like.

Conversely, it can be seen that the polyamide resin composition of Comparative Example 1 comprising an insufficient amount of the aromatic polyamide resin and an excess of the aliphatic polyamide resin suffers from deterioration in detachability and the like; the polyamide resin composition of Comparative Example 2 comprising an excess of the aromatic polyamide resin and an insufficient amount of the aliphatic polyamide resin suffers from deterioration in impact resistance, heat resistance, and the like; the polyamide resin composition of Comparative Example 3 comprising an insufficient amount of the glass fiber suffers from deterioration in impact resistance, heat resistance, rigidity, and the like; and the polyamide resin composition of Comparative Example 4 comprising an excess of the glass fiber suffers from deterioration in adhesion, detachability, and the like. It can be seen that the polyamide resin composition of Comparative Example 5 comprising an insufficient amount of the poly(ether ester amide) block copolymer suffers from deterioration in adhesion and the like; the polyamide resin composition of Comparative Example 6 comprising an excess of the poly(ether ester amide) block copolymer suffers from deterioration in detachability and the like; and the polyamide resin composition of Comparative Example 7 comprising polyamide 6-polyethylene oxide block copolymer (D2) instead of the poly(ether ester amide) block copolymer according to the present disclosure suffers from deterioration in detachability and the like. In addition, it could be seen that the polyamide resin composition of Comparative Example 8 comprising an insufficient amount of talc suffers from deterioration in heat resistance and the like; and the polyamide resin composition of Comparative Example 9 comprising an excess of talc suffers from deterioration in impact resistance and the like.

Exemplary embodiments have been disclosed herein, and although specific terms are employed, unless otherwise noted, they are to be interpreted in a generic and descriptive sense only and not for purpose of limitation. Although some embodiments have been described above, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

It is within the scope of this disclosure for one or more of the terms “substantially,” “about,” “approximately,” and/or the like, to qualify each adjective and adverb of the foregoing disclosure to provide a broad disclosure. As an example, it is believed those of ordinary skill in the art will readily understand that, in different implementations of the features of this disclosure, reasonably different engineering tolerances, precision, and/or accuracy may be applicable and suitable for obtaining the desired result. Accordingly, it is believed those of ordinary skill will readily understand usage herein of the terms such as “substantially,” “about,” “approximately,” and the like.

For example, numerical values provided throughout this disclosure can be approximate, and for each range specified in this disclosure, all values within the range and all subranges within the range are also disclosed. Approximate values can be calculated, and it is believed that each value can vary by for example plus or minus about 10%, for example plus or minus about 5%, for example plus or minus 4%, for example plus or minus 3%, for example plus or minus 2%, for example plus or minus 1%, for example plus or minus less than 1%, for example plus or minus 0.5%, and as another example less than plus or minus 0.5%, including all values and subranges therebetween for each of the above ranges.

The use of the term “and/or” includes any and all combinations of one or more of the associated listed items.

As used herein, indefinite articles “a” and “an” refer to at least one (“a” and “an” can refer to singular and/or plural element(s)).

What is claimed is:

1. A polyamide resin composition comprising:
about 100 parts by weight of a polyamide resin comprising about 5 wt% to about 55 wt% of an aromatic polyamide resin and about 45 wt% to about 95 wt% of an aliphatic polyamide resin;
about 100 parts by weight to about 200 parts by weight of glass fiber;
about 20 parts by weight to about 25 parts by weight of a poly(ether ester amide) block copolymer; and
about 0.1 parts by weight to about 2 parts by weight of talc,
wherein the poly(ether ester amide) block copolymer is a block copolymer of a reaction mixture comprising an amino carboxylic acid having 6 or more carbon atoms, a lactam or a salt of diamine-dicarboxylic acid, polytetramethylene glycol, and a dicarboxylic acid having 4 to 20 carbon atoms.

2. The polyamide resin composition according to claim 1, wherein the aromatic polyamide resin is a polymer of an aliphatic dicarboxylic acid and an aromatic diamine.

3. The polyamide resin composition according to claim 1, wherein the aliphatic polyamide resin comprises polyamide 11, polyamide 12, polyamide 4.6, polyamide 6.6, polyamide 6.10, polyamide 6.12, polyamide 10.10, and/or polyamide 10.12.

4. The polyamide resin composition according to claim 1, wherein the glass fiber has a rectangular or elliptical cross-section, a cross-section aspect ratio (long-side length/short-side length in cross-section) of about 1.5 to about 10, and a short-side length of about 2 µm to about 10 µm in cross-section.

5. The polyamide resin composition according to claim 1, wherein the glass fiber and the poly(ether ester amide) block copolymer are present in a weight ratio of about 1:0.1 to about 1:0.2.

6. The polyamide resin composition according to claim 1, wherein the poly(ether ester amide) block copolymer and the talc are present in a weight ratio of about 1:0.005 to about 1:0.08.

7. The polyamide resin composition according to claim 1, wherein the polyamide resin composition has a bonding strength (potential energy) of about 700 mJ to about 950 mJ, as measured upon detachment of a specimen having a size of 50 mm × 50 mm × 4 mm from a glass plate having a size of 25 mm × 25 mm × 0.7 mm by dropping a dart having a mass of 10 g to 500 g from a height of 50 cm onto the specimen using a dropping tester, with the dart secured to an upper end of the dropping tester and the specimen secured to a lower end thereof, in accordance with a DuPont drop test, in which 0.018 g of a polyurethane-based bonding agent is coated to a thickness of 1 mm on the specimen at 110° C. and the glass plate is attached to the specimen via the bonding agent, followed by curing the bonding agent at 25° C. and 50% RH for 72 hours.

8. The polyamide resin composition according to claim 1, wherein the polyamide resin composition prevents a bonding agent from remaining on a specimen having a size of 50 mm × 50 mm × 4 mm upon detachment of the specimen from a glass plate having a size of 25 mm × 25 mm × 0.7 mm by dropping a dart having a diameter of 5 mm onto the specimen at a dropping rate of 20 mm/min using a universal testing machine (UTM), with the dart secured to an upper jig of the UTM and the glass plate secured to a lower end thereof, in which 0.018 g of a polyurethane-based bonding agent is coated to a thickness of 1 mm on the specimen at 110° C. and the glass plate is attached to the specimen via the bonding agent, followed by curing the bonding agent at 25° C. and 50% RH for 72 hours and heating the bonding agent at 75° C. for 15 min.

9. The polyamide resin composition according to claim 1, wherein the polyamide resin composition has a notched Izod impact strength of about 14 kgf·cm/cm to about 30 kgf·cm/cm, as measured on a ⅛″ thick specimen in accordance with ASTM D256.

10. The polyamide resin composition according to claim 1, wherein the polyamide resin composition has a heat deflection temperature (HDT) of about 175° C. to about 190° C., as measured under a load of 1.82 MPa at a heating rate of 120° C./hr in accordance with ASTM D648.

11. The polyamide resin composition according to claim 1, wherein the polyamide resin composition has a flexural modulus of about 90,000 kgf/cm² to about 180,000 kgf/cm², as measured on a 6.4 mm thick specimen at a rate of 2.8 mm/min in accordance with ASTM D790.

12. A molded article formed of the polyamide resin composition according to claim 1.

13. An electronic device housing comprising:
a glass frame; and
a plastic molded article formed of the polyamide resin composition according to claim 1 adjoining at least one surface of the glass frame.
